(19) United States
(12) Patent Application Publication
(10) Pub. No.: US 2009/0147723 A1
(43) Pub. Date: Jun. 11, 2009

(54) Method and Device for Data Routing and Bandwidth Reservation in Small Scale Distributed Networks

(75) Inventors: Zuyuan Fang, Hongkong (CN); Jihui Zhang, Hongkong (CN); Quanlong Ding, Hongkong (CN)

Correspondence Address: WELLS ST. JOHN P.S., 601 W. FIRST AVENUE, SUITE 1300, SPOKANE, WA, 99201, US

(73) Assignee: Hong Kong Applied Science and Technology Research Institute Company Limited

(21) Appl. No.: 11/952,909

(22) Filed: Dec. 7, 2007

(51) Int. Cl. H04B 7/14; H04Q 7/00

(52) U.S. Cl. 370/315; 370/329

(57) ABSTRACT

A data routing and/or bandwidth reservation method for small scale distributed network in which each member has a topological view of the whole network. Route selection is performed at a source member and bandwidth reservation is conducted along the selected route. Upon start up or joining the network each member of the network establishes and maintains a list of information for all other devices in the network, which serves as a topological view of the network. To reduce communication overhead during information collection, a priority based broadcast scheduling is adopted. When a device intends to establish a connection with another device it selects a route based on its own preference and current network topology. The device then reserves bandwidth along the selected route. Bandwidth reservation uses a mutually exclusive bandwidth reservation protocol which guarantees only one application can reserve bandwidth at a time.

### BACKGROUND OF THE INVENTION

1. Field of the Invention

This invention relates to wireless communication in distributed networks. In particular, the invention relates to data routing, or multi-hop routing in small scale distributed networks, where each device or node in the network can be used as a packet carrier and forwarder to relay data packets from a source to a destination hop by hop. The invention also relates to bandwidth reservation along the route between the source and the destination.

2. Background Information

A distributed network is a network in which there is no central network controller to manage the activities of the network and each member (i.e. node or device) of the network has equal privileges and rights and access to the network resources is done thru negotiation among the member in the network. Members are free to join and leave the network at will. A Wireless Personal Area Network (WPAN) is an example of a small-scale distributed network that can be used for home entertainment, home office and conference room network applications. In a home entertainment environment, typical network applications include video streaming like watching TV and playing DVDs, playing games, downloading files and browsing websites. In a home office and conference room environment, typical network applications include multimedia presentation and file sharing. Such networks have a number of limiting and unique characteristics including small size, small coverage area and a small number of users. The members of the network are also heterogeneous in terms of computation and power capability. For example, members of the network can simultaneously include PCs, PDAs, digital cameras as well as printers. They can be mains powered or battery powered.

Ultra-wideband (UWB) radio technology can be used for short-range high-bandwidth communications and is ideally suited to use in WPAN applications. A WiMedia UWB radio platform has been proposed by the WiMedia standard committee by incorporating media access control layer (MAC) and physical layer (PHY) based on Multi-band Orthogonal Frequency Division Multiplexing (MB-OFDM) technology. UWB radio can support very high data rates of up to 480 Mbps in the current version or higher in the future version and has lower power consumption. However, UWB technology has some drawbacks. Its communication range is limited to only about 30 feet or 10 meters, which is not much bigger than the size of a typical size room. This short range means that in many home, office or large conferencing applications some devices may be located out of direct communication range of each other. Additionally, low power means that the network is susceptible to interference from electrical noise and environmental obstacles such as walls.

An ad-hoc network is one in which each node is willing to forward data for other nodes in the network. Several distributed routing protocols have been proposed for ad-hoc networks and can be used to extend the communication coverage of UWB beyond direct peer-to-peer range. However, these routing protocols generally depend on local information and each node does not have a global view of the network. In addition, although the use of ad-hoc routing protocols network can solve the range problem, they do not address Quality of Service (QoS) issues, which are important to support real-time streaming applications.

One way to solve the QoS problem is through bandwidth reservation. Several bandwidth reservation schemes have been proposed for wireless ad-hoc networks that use a distributed routing protocol to find a route through the network and perform bandwidth reservation along the route. They share the same problem as distributed routing protocols in route selection procedure. Some schemes suffer from race conditions in which a slot is incorrectly reserved by multiple reservations and parallel reservation problems because bandwidth reservation is conducted in a distributed way and can be conducted concurrently. Parallel reservation is a frequent cause for failure of bandwidth reservation. Most existing bandwidth reservation target large scale ad-hoc networks and rely on a complicated routing protocol to conduct route establishment and recovery. Such schemes have high network overhead and are not suitable for small size WPANs. Additionally, existing schemes do not jointly consider source preference, device heterogeneity and diverse traffic requirements in WPANs.

### SUMMARY OF THE INVENTION

Accordingly, it is an object of the current invention to provide a method of routing and bandwidth reservation that overcomes or at least ameliorates problems with existing schemes. It is an alternative object of the invention to provide a data routing method for small-scale distributed networks that is particular suits to UWB based WPANs.

In view of the foregoing, there is disclosed herein a data routing and/or bandwidth reservation method for small scale distributed network in which each member, i.e. device or node, in the network has a topological overview of the whole network, route selection is performed at source member and bandwidth reservation is conducted along the selected route. Upon start up or joining the network each member of the network establishes and maintains a list of information for all other devices in the network, which can be used to build a topological view of the network. To reduce communication overhead during information collection, a priority based broadcast scheduling is adopted. When the network is stable each device has a global view of the network. Once the network topology or device information changes the updated information is propagated to the whole network with high priority. When a device intends to establish a connection with another device it selects a route based on its own preference and current network topology. The device then reserves bandwidth along the selected route. Bandwidth reservation uses a mutually exclusive bandwidth reservation protocol which guarantees only one connection can reserve bandwidth at a time.

The data routing and bandwidth reservation method comprises three main functional components. These are information collection, route selection and bandwidth reservation. Optionally, the method may also include rate adaptation, transmit power control and service discovery components.

Information collection performs the broadcasting and collecting of device information of the whole network. Route selection performs selection of relay routes according to the application requirements at the source device. Bandwidth reservation performs mutually exclusive bandwidth reservation along the selected relay route.

Rate adaptation and transmit power control perform efficient packet transmission at the link level. Service discovery performs searching for services provided in the network and provides services for other devices.

There is also disclosed herein a device having a relay application for allowing the device to participate as member of a network having data routing and bandwidth reservation according to the invention.

Further aspects of the invention will become apparent from the following description, which is given by way of example only.

### BRIEF DESCRIPTION OF THE DRAWINGS

An exemplary form of the present invention will now be described by way of example only and with reference to the accompanying drawings, in which:

FIG. 1 diagrammatically illustrates a protocol stack for the exemplary embodiment of the invention,

FIG. 2 diagrammatically illustrates functional components of the relay system component of the invention and their interrelationship,

FIG. 3 diagrammatically illustrates message and control flow between MAC and relay system layers of the protocol stack of FIG. 1,

FIG. 4 diagrammatically illustrates flow of the relay system initialization procedure,

FIG. 5 diagrammatically illustrates the main control flow of the relay system for update of device information,

FIG. 6 diagrammatically illustrates link information message processing by the relay system,

FIG. 7 diagrammatically illustrates device information message processing by the relay system,

FIG. 8 diagrammatically illustrates the operation procedure of broadcast schedule development by the relay system,

FIG. 9 diagrammatically illustrates control flow of transmitting device information by the relay system, and

FIG. 10 diagrammatically illustrates data transmission flow in a method according to the invention.

### DESCRIPTION OF THE EXEMPLARY EMBODIMENTS

In a multi-hop communication scenario not all members of the network are in direct communication range with every other member in the network. In the following description the term neighbor is used to donate those members of the network that are in direct communication. That is to say, the neighbors of a device A are those other devices with which device A can communicate directly.

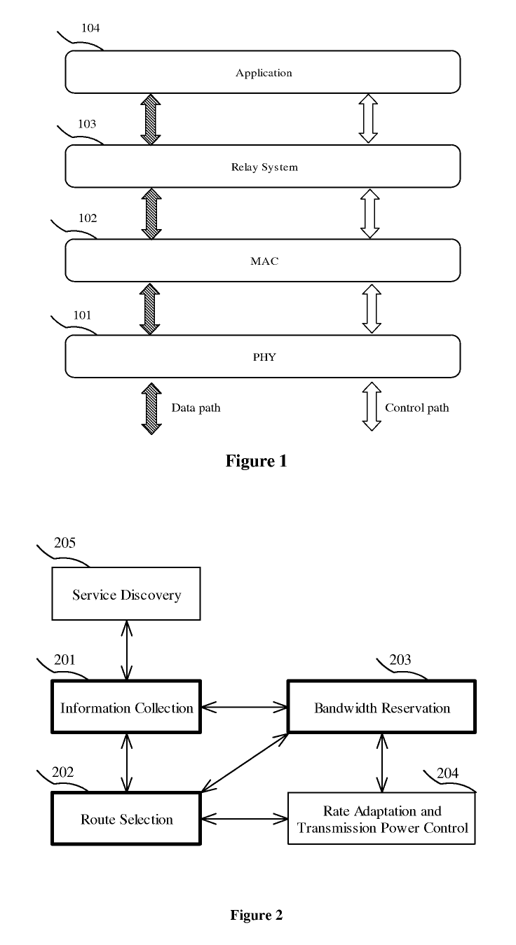

Reference will now be made in detail to an exemplary embodiment of the present invention as practiced in a Time Division Multiple Access (TDMA) based MAC protocol in which every device in the network sends out ‘hello’ messages, by means of beacon frames, to announce its existence and provide other supplementary information in every superframe. The protocol stack for the exemplary embodiment is shown in FIG. 1. A relay system according to the invention 103 is built on top of the MAC layer 102. It utilizes services provided by MAC 102 and PHY 101, and provides end-to-end data transmission services to the applications 104. For example, the MAC provides a broadcast channel for the relay system to send control messages and a distributed bandwidth reservation mechanism, namely distributed reservation protocol (DRP), to reserve communication resources between neighbors in the network. These characteristics of the exemplary embodiment are not intended however to limit the scope of use or functionality of the invention. It is envisaged that the invention may be adapted for use in other protocols and stack architectures or that may itself become the basis of a new protocol.

FIG. 2 illustrates functional components of the relay system and their interrelationship. The functional components are Information Collection, Route Selection, Bandwidth Reservation, Rate Adaptation and Transmit Power Control and Service Discovery. These components are implemented using software routines, drivers, objects and components operating in the network members to provide methods of the invention. The three main functional components of the system are information collection, route selection and bandwidth reservation. Optionally the relay system also includes the rate adaptation and transmit power control, and service discovery functions. Upon start up or joining the network each member of the network establishes and maintains a list of information for all other devices in the network so that it has a topological overview of the entire network. The information collection component is responsible for establishing and maintaining this list by collecting, broadcasting and, if necessary, re-broadcasting of device information by each member of the network. In this way, each device has a global view of the entire network. Whenever the network topology or device information changes, updated information is propagated to the whole network with high priority. When a device intends to establish a connection with another device in the network, it selects a communication route based on its own preference and current network topology. The route selection component of the relay system is responsible for selection of the communication route. Because each member of the network has a global overview of the entire network, route selection is done at the source device according to the application requirements. The source device then reserves bandwidth along the selected route. The bandwidth reservation component is responsible for bandwidth reservation along the selected communication route. Bandwidth reservation uses a mutually exclusive bandwidth reservation protocol, which guarantees that only one connection can reserve bandwidth at a time. The remaining components of the invention, rate adaptation and transmit power control, and service discovery are optional components that can be used to further enhance network performance. Rate adaptation and transmit power control perform efficient packet transmission at the link level. Service discovery performs announcing and searching for services provided in the network and provides services for other devices. In this scheme, the system operation starts from global information collection. The information collection procedure is invoked periodically to keep information updated, or on demand if there is any change of such information. Route selection and bandwidth reservation procedures are invoked on demand whenever there is a request from an upper layer.

The three main functional components of the system; information collection, route selection and bandwidth reservation; will now be described in more details.

### 1. Information Collection

Each member of the network needs to collect and propagate some information for every other member of the network to establish a global view of the entire network. The detail of the information collection functionality is presented in following part. To facilitate the description, following table defines several information parameters that will be addressed.

| Information Type | Information Description |
|---|---|
| Device ID | The unique identifier of the device in the network. It could be |
| | for example Media Access Control address (MAC address) or |
| | Ethernet Hardware Address (EHA) or hardware address or |
| | adapter address attached to the device's network adapter (NIC). |
| Relay Capability | Denotes whether the device is willing and has capability to |
| | relay packets for other members of the network. For optimum |
| | performance of the network every device should have relay |
| | capability for others and if necessary it can be re-configured |
| | by the user. |
| Device Type | Denotes the device's type or category, such as a printer, PC, |
| | PDA, mobile phone, a digital camera etc. |
| Application | Denotes what kind of applications the device can support/run. |
| Capability | |
| Power Type | Denote whether the device is mains powered or battery |
| | powered; |
| Remaining Power | Denote the remaining power for operation. The remaining |
| | power for both mains powered device and battery device can |
| | be represented in a uniform way, and can be quantified into |
| | several levels. The remaining power for mains powered |
| | device is always set at the highest level, while the remaining |
| | power for the battery powered device is represented according |
| | to its actual remaining power. |
| Link Condition | Denotes the condition or quality of the wireless, or other, |
| | connection with every other device with which the member |
| | can communicate. |
| Distance/Localization | Denotes the location and/or distance of every other device |
| | with which the member can communicate. |
| Link Bandwidth | Denotes the bandwidth of the wireless, or other, connection |
| | with every other device with which the member can |
| | communicate. |

Two types of messages are adopted for information collection in the invention. These are link information message and device information message. Link information messages are used to request or send link quality information between neighbors, and device information message are generated by relay system to propagate network information. Fields in the device information message can be classified into two categories: mandatory and optional, where the mandatory part is the minimal information for the system to provide basic functionality and the optional part is the information for the system to provide enhanced features. The mandatory information items include device ID, relay capability, power type, number of neighbors, device address, link quality and bandwidth to each neighbor device etc. The optional information includes remaining power, device type and application capability etc. In addition, device information message also needs to include a sequence number, which is maintained by the initiator of the device information message. The information collected by the scheme is not restricted to those discussed above. More information could be collected as long as the network and system can afford it.

System information for the whole network is obtained through local information collection and broadcasting. Every device participates in establishing and maintaining lists by all members in the network by 1) broadcasting their own information, 2) listening for the broadcasts of other devices, and 3) if necessary re-broadcasting information of other devices.

Firstly, each device collects its own device information locally. Then the device forms a device information message and broadcasts its own device information. By overhearing device information messages broadcasted by neighboring devices, a device can obtain its neighbors' device information. Link information can be measured by local device. Generally, local device can compute the link quality based on link quality information or signal strength of received packets from the link. A device queries its neighbors for the link quality between them and the neighbors send back link quality information, which is incorporated into the device information message. In a multi-hop communication scenario not all members of the network are in direct communication range and so not every device can overhear all the device information messages broadcast by every other device. Therefore device information messages need to be re-broadcast by other members of the network so that all members can collect and store the information. The big challenge with global device information collection is that the communication bandwidth that is used for information collection might be too large to be afforded by the network. In this invention, the collection procedure is working on a relatively small network. In order to further reduce the communication overheard, a priority-based broadcast scheduling algorithm is used, which will be discussed in following part. In order to facilitate network information collection and propagation, following data structures are maintained by each device:

| Data Structure | Description |
|---|---|
| Device | Each device in the network keeps a list to maintain device |
| information list | information for itself and all overheard devices. Originally this |
| | list has only one entry that represents its own device |
| | information. It will eventually include an entry for each device |
| | in the whole network. There are two type of information fields |
| | associated with each entry: one type is device information, |
| | which is used to keep device information carried by the device |
| | information message. Another type is used for device control, |
| | which is used to check validity of the device information and |
| | conduct broadcast control, which will be discussed in detail in following |
| | part. |
| Device broadcast | Device broadcast coverage list is used for local device to decide |
| coverage list | whether it needs to re-broadcast overheard information. There is |
| | a record for each device overheard by the local device so far and |
| | eventually every device in the network. Each record contains a |
| | set of broadcast flags for all neighbors of the local device. For |
| | example, Flag (A, M) represents device information A for |
| | neighbor device M, and is set if M can overhear A's device |
| | information without the help of re-broadcast. |
| Neighbor list (for | This list maintains neighbor control information for a local |
| local device only) | device. The list contains a record for each neighboring device. |
| | Each records comprises three fields for: |
| | 1) device ID of neighbor device, 2) link measurement counter, |
| | which is used to decide when to perform link quality |
| | measurement, and 3) live counter, which is used to maintain |
| | liveness of the device. |
| Broadcast priority | Each item in the queue is a pointer to an entry in the device |
| queue | information list, and denotes which device information is |
| | pending for broadcasting currently. According to the available |
| | bandwidth, one or multiple device information items starting |
| | from the head of the queue will be broadcasted/re-broadcast |
| Link information | Each item in the queue is a pointer to an entry in the device |
| request queue | information list, and denotes that the link information for the |
| | device should be obtained in the current superframe through |
| | issuing link information request message. |

Control fields of device information in the device information list are described as follows:

| Field | Description |
|---|---|
| sequence | The sequence number of the latest device information |
| number | message received. |
| basic period | The basic broadcast period for the device. |
| current period | Current used broadcast period. |
| broadcast | Broarcast counter. |
| counter | |
| broadcast flag | Whether the device information should be broadcasted or |
| | not. Local device's information is always set as broadcast |
| | required, while others' is decided by broadcast |
| | requirement checking procedure, which will be discussed |
| | in the following part. |
| Event flag | It is used to maintain device information update status, |
| | which is further used to decide the priority of broadcast |
| | queue. Two types of event flag are defined as follows: |
| | UPDATE denotes that the device information item has |
| | been updated since last broadcast; NOUPDATE denotes |
| | that there is no any update since last broadcast. |

### Information Collection Control Flow

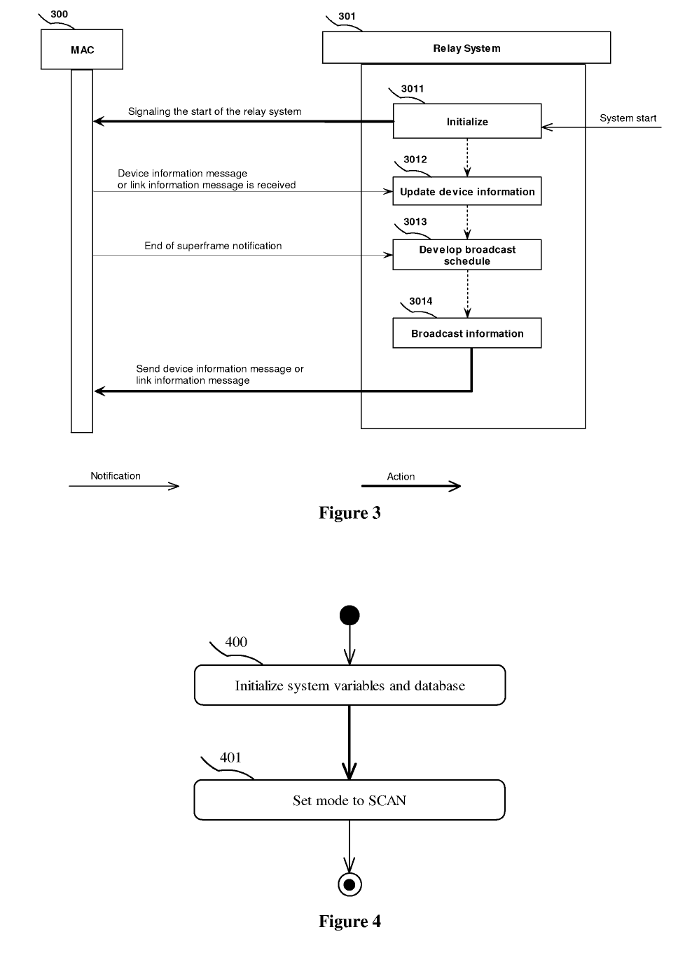

The information collection procedure is invoked periodically in term of a MAC superframe. FIG. 3 illustrates a preferred implementation in which the relay system is an event driven system. The relay system 301 is invoked by a system start event, which could originate from the MAC or application levels of the stack. After being invoked, the relay system is initialized at step 3011 and then it notifies the MAC of its existence. Whenever a message related to the relay system is received by the MAC it is passed to the relay system for processing at step 3012. The relay system develops its Broadcast priority and Link information request queues at step 3013 and transmits device and link information messages at step 3014 at the end of each superframe. The operation for these steps 3011-3014 is discussed in detail in next sections.

Initialization (Step 3011)

The initialization procedure is shown in FIG. 4. At step 400 the relay system initializes system variables and local data structures (lists and queues). The relay system operates in either SCAN or NORMAL mode. When the system starts up or after a system reset, the relay system enters into the SCAN mode. In this mode, a device does not send any device information message and link information message. It overhears the channel and tries to collect as much information as possible and populate the information lists and queues. After a pre-defined period of time, the system enters into NORMAL mode. In this mode, it can send its own device information and request and reply link information from others according to the lists and queues.

### Update Device Information (Step 3012)

The main control flow of the update of device information is shown in FIG. 5. At step 500, a message is passed to the relay system from the MAC. At step 501, a function module checks the message type. If it is a link information message, it is passed to a link information processing procedure at step 502. If it is a device information message, it is passed to a device information processing module at step 503. After the message is processed, the system goes to idle at step 504.

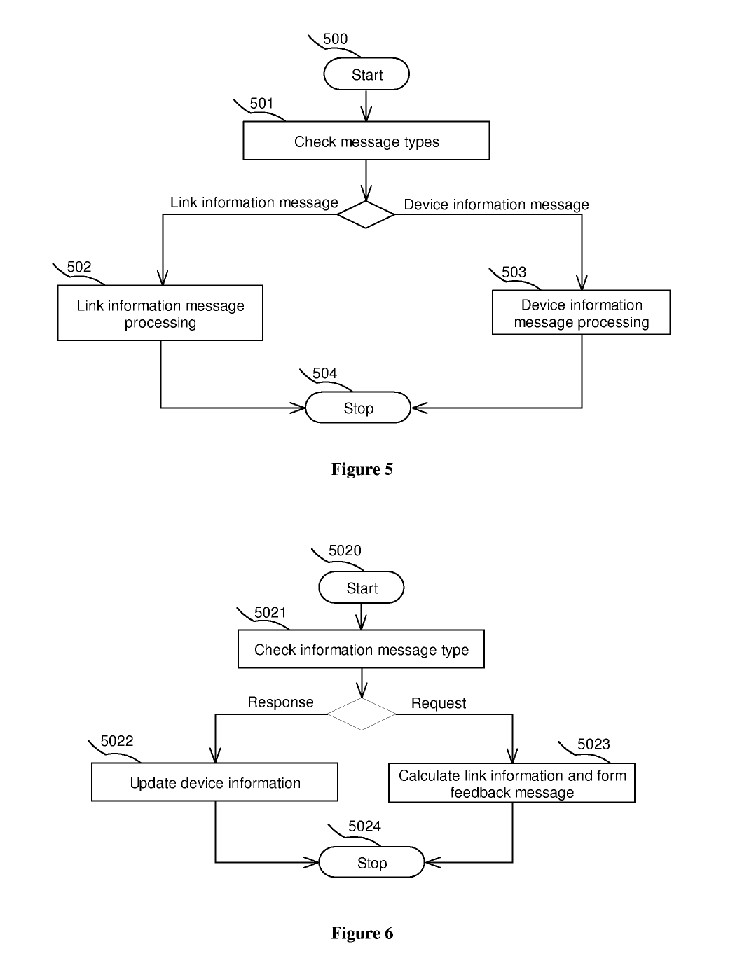

Link information message processing is shown in FIG. 6. After the link information message is received at step 5020 a function module firstly checks whether the message is a link information request (step 5021). If yes, then the link quality is measured and a link information response message is sent out (step 5023). Otherwise, the device information list is updated according to the message information (step 5022). The system goes to idle (step 5024).

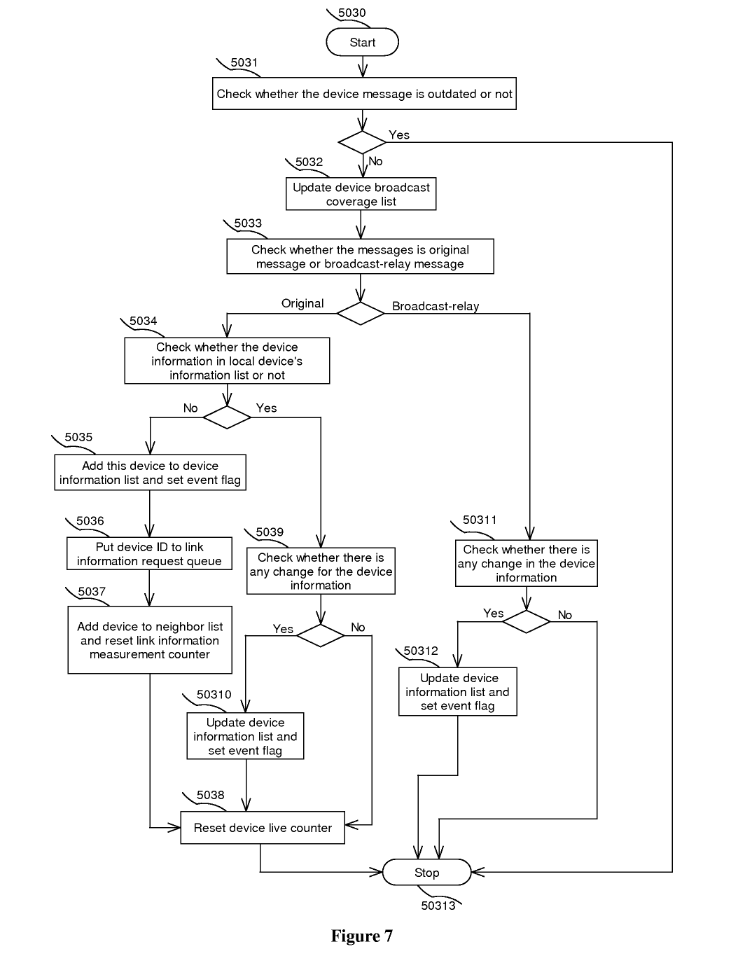

Device information message processing is shown in FIG. 7. After a message is received (step 5030) the function module checks whether the message is outdated or not (step 5031). A message is outdated if the sequence number of the message is less than or equal to the sequence number maintained by local device or vice versa. If the message is outdated, then the function module goes into step 50313 to stop the procedure. If the message is not outdated, device broadcast coverage list is update accordingly (step 5032, the detail operation will be discussed in following part). Then a check operation is conducted (step 5033) to see whether the device information message is an original message from source device A or re-broadcasted by another device B. If it is an original message, the function module checks whether the local device has previously obtained information for source device A or not (step 5034). If the local device has not got A's information, then A's information is added to the local Device Information list and its eventflag is set as UPDATE (step 5035) and A's device ID is put into the link information request queue (step 5036). The device ID is added to neighbor list and the link information measurement counter is reset (step 5037). The live counter for device A is also reset (step 5038) and the procedure stops (step 50313).

If the local device has previously received A's information, then the function module checks whether there is any change in A's information (step 5039). This can be done by checking whether the message sequence number is larger than the sequence number kept in local database. If there is no change, then the function module resets the device's live counter (step 5038) and stops (step 50313). If there is some change, then the function module updates device information list and sets device eventflag as UPDATE (step 50310), updates the device live counter (step 5038) and stops (step 50313).

If the device information message is a re-broadcast (broadcast-relay) message the function module checks whether there is any change in the device information message (step 50311). If there is a change, i.e. sequence number is larger, device information list is updated and its eventflag is set as UPDATE (step 50312), and the operation is stopped (step 50313). Otherwise the procedure is stopped (step 50313).

At steps 5039 and 50311, the device information message is checked against the local database to see whether there is any change. In order to achieve this, each device information message is associated with a sequence number, which can only be updated by the initiator of the message and updated only when there is any change for the device information. Therefore, when a device receives a device message from other devices, it can compare the sequence number stored in the local database with the one carried in the message. If the one recorded in local database is less than later received one, then it knows that the device information has been changed. At steps 50310 and 50312, when the device information is updated, the relay system needs to do three things: 1) update each item of the device information according to the received message. 2) set event flag as UPDATE. 3) check whether any neighbors have joined or left for this device. If there is, the relay system needs to update those neighbors' device information accordingly. This is essential step of so called “reverse validity checking” which will be discussed in following paragraph.

### Broadcast Schedule Development (Step 3013)

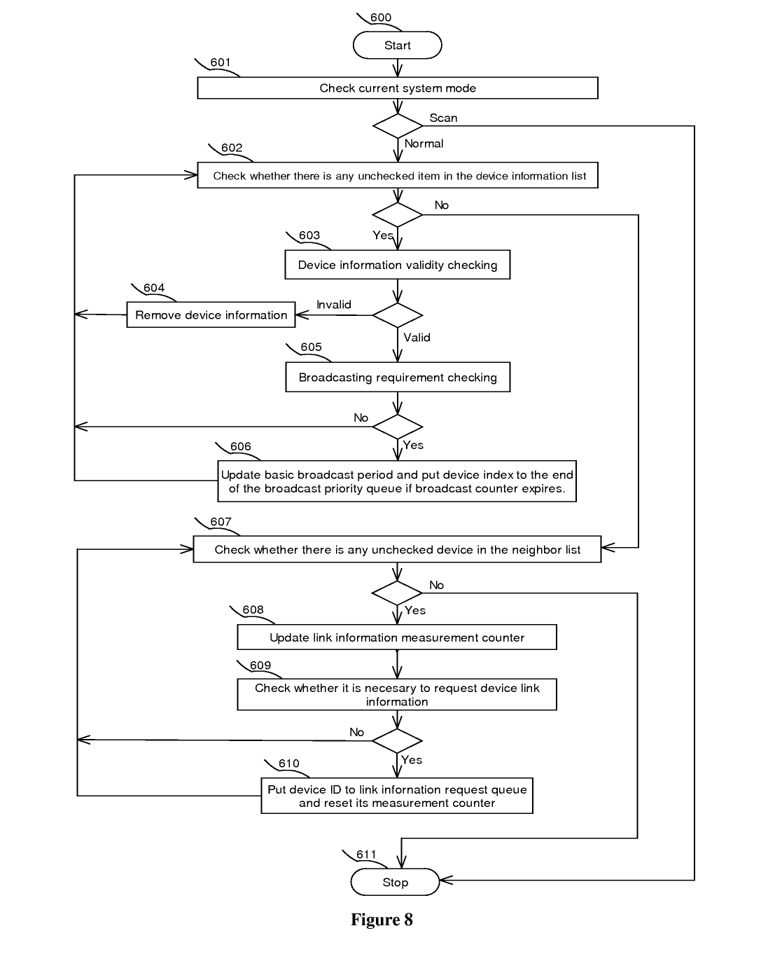

The operation procedure for broadcast schedule development is shown in FIG. 8. After this procedure is invoked (step 600), the function module checks whether the system is in SCAN mode. If the system is in SCAN mode, the procedure goes to step 611 to stop the operation.

If the system is in NORMAL mode, the function module conducts a processing operation on each item in the list. It firstly checks whether there is any unprocessed device record in the device information list (step 602). If there is no unprocessed record in the list, then the procedure goes into step 607. If there are unprocessed device information records in the list, then the function module conducts validity checking (step 603). If the information item is invalid, which means the device information is outdated, then the function module goes to step 604 to remove device's information from both device information list, and neighbor list if the device is a neighbor, and goes to step 602. Otherwise, the function module conducts broadcast requirement checking (step 605). If there is no need to broadcast/re-broadcast this information item, the function module goes into step 602, otherwise, the device's basic broadcast period is updated (which will be discussed in following part) and its device ID is put to the end of the broadcast priority queue if its broadcast counter expires or its status is set as UPDATE. (step 606). Before putting device ID to the broadcast priority queue, the function module needs to check whether it is already in the queue. If so, this step does nothing. Then the control flow goes into step 602. If all device information items have been processed, then the function module checks whether there is any processed record in the neighbor list (step 607). If there is no, the function module goes to step 611 to finish the operation. If there is, then the function module goes to step 608 to update link information measurement counter for the device, and checks whether it is necessary to request the device's link information (step 609). If not need, the function module goes to step 607. If needed, the function modules puts the device ID into the link information request queue and reset its link measurement counter (step 609), and then goes to step 607.

### Device Information Validity Checking

At step 603, the function module checks whether the information message is valid or not. The objective for this check is to see whether the device information has been outdated or not. Two types of approach are proposed for validity checking, based on whether a device is a neighboring device or not. If the device is a neighboring device then a live counter is used to maintain its validity. The live counter of a neighboring device information record is decreased in each superframe and reset to maximum value when the neighbor's device information is received. If the live counter reaches zero, it means that the neighbor's information has not been received for a predefined period (or number of super frames), which implies the neighbor may already left the network or power off, so its information item is outdated.

If the device is not a neighbor, which means its information is received through re-broadcasting by an intermediary device then the flowing, so-called, reverse checking mechanism is used to check its validity. Whenever an information record of device A is overheard directly or through neighbors re-broadcast, its device information is updated. Then a further check is made to see whether a neighbor, say B, is joining or leaving device A. If B is joining, then an entry should be added in local device's information list, and A is added to B's neighbor list. If B is leaving, then A should be removed from B's neighbor list. This update operation is conducted in step 50312 and 5039. For any information record, if it does not have any neighbors, then its information item should be marked as invalid.

### Re-Broadcasting Requirement Checking

At step 605, the device information should be checked, to determine whether re-broadcasting is necessary. If re-broadcasting is necessary, the device's broadcast flag field of corresponding entry would be labeled as re-broadcasting; otherwise, the broadcast flag field of the entry is labeled as no re-broadcasting.

Since a wireless channel is a broadcast channel, it is more efficient for a device to avoid re-broadcasting information that has already been overheard by all its neighbors. A Broadcast Checking mechanism is adopted for this purpose. Each device maintains a device broadcast coverage list . . . . It is updated and used as follows. If information of device A is received from device B, then in the record of device A, all broadcast flags for B and its neighbors are set. This operation is conducted at step 5031. If all flags have been set for device A's entry when checking is conducted at step 605, then device information is marked as no need re-broadcast, otherwise, it is marked as re-broadcast required. After this, the function module removes no need re-broadcast device information item from broadcasted priority queue if its device information has been put to the broadcast priority queue previously.

### Priority-Based Broadcast Scheduling

In FIG. 8, at step 606 there is a requirement to update the basic broadcast period. This is a crucial step to keep each device's information updated while maintaining a relatively lower communication overhead. The rationale and the method of doing this are illustrated as follows.

The bandwidth used for information collection must be limited such that there is enough remaining bandwidth for other function modules. While at the some time a device may have a large amount of information to be broadcasted. Sending it all at a time may require far more than its bandwidth limit. Higher priority should be given to information important to operating of the relay system and other lower priority information would be delayed to send later.

In the priority-based broadcast scheduling mechanism, each device's information item is associated with three parameters to control its broadcast frequency, namely, basic period, current period, and broadcast counter. Basic period determines the basic broadcasting period whenever the device information is updated. It can be computed based on the broadcast priority of each device. The higher the broadcast priority of a device, the shorter its basic period. Current period is used to maintain the current broadcast period. Both basic period and current period are defined in terms of number of super frames. Broadcast counter is used to invoke a broadcast operation based on currentperiod. The usage of broadcast counter is discussed in following part.

Specifically, basic period is determined by broadcast priority, which is further determined using the following rules. The local device information has highest broadcast priority. Other devices are ranked by the number of neighbors they have and other control parameters. For example, a device has more neighbors having higher priority, and a device has higher remaining power having higher priority. As an example, a more concrete algorithm can be used to compute basic period as follows. Any other algorithm can apply here in case reasonable basic period could be calculated.

The notations are defined as follows:

| Notation | Description |
|---|---|
| P_{l,,j} | Link priority, which is the priority factor determined by the |
| | number of links device j has. Here each peer of neighbor |
| | devices is defined to have one link between them. |
| P_{p,,j} | Power priority for device j |
| P_{r,,j} | Relay priority for device j. |
| N | Number of devices in the whole network. |
| Nⱼ | Number of links device j has. |
| Pⱼ | Broadcast priority for device j. |
| Bⱼ | Power level for device j |
| Bₘₐₓ | Maximal power level. |
| Rⱼ | Relay property of device j. Value 1 represents the device is |
| | capable of relay. Value 0 represents it is not. |
| α | Smoothing constant (0 < α < 1). |
| Tᵢ | Basic period of local device i. |
| Tⱼ | Basic period of device j. |

If we define:

$$\begin{matrix}{P}_{1 , j} = \frac{{N}_{j}}{N} & [ 1 ] \\ {P}_{p , j} = \{ \begin{matrix}1 , & mains powered device \\ \frac{{B}_{j}}{{B}_{max}} , & battery powered device\end{matrix} & [ 2 ] \\ {P}_{r , j} = {R}_{j} & [ 3 ]\end{matrix}$$

Then the broadcast priority for device j is determined by

$${P}_{j} = \{ \begin{matrix}1 , & own message \\ α {P}_{l , j} + ( 1 - α ) {P}_{r , j} {P}_{p , j} , & otherwise\end{matrix} \qquad [ 4 ]$$

And the basic period for device j is determined by

$${T}_{j} = \frac{{T}_{i}}{{P}_{j}} \qquad [ 5 ]$$

The algorithm works as follows. Initially, for a device information record that needs to be broadcast, its current period is set as basic period. It is increased to a predefined maximal threshold after several times of successful broadcast transmissions. It will be reset to the basic period whenever there is an update for the device's information. The broadcast counter is used to decide when the device information should be broadcasted. Initially its value is set as current period and it is decreased at the end of each superframe. The device ID of the information record is put to the broadcast priority queue if the broadcast counter researches zero. The broadcast priority queue is used to maintain device information to be broadcasted in the current superframe. At the end of each superframe, all higher priority device information items that can be accommodated in one broadcast package are sent out.

### Broadcast Information (Step 3014)

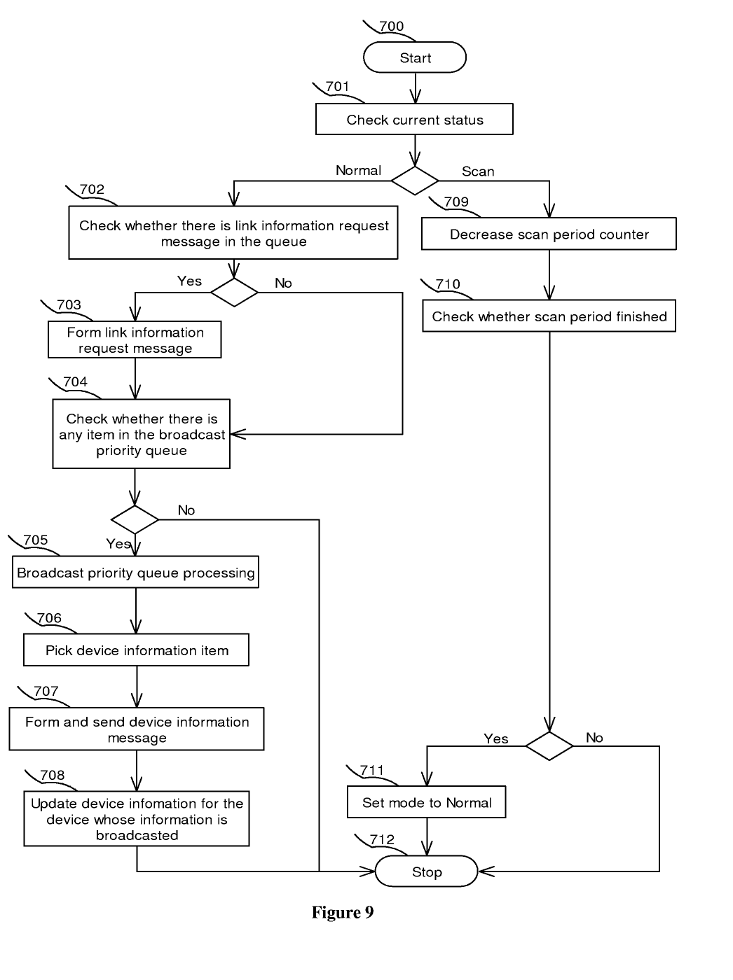

At the end of each superframe, the system needs to perform device information transmission. The control flow of transmitting device information is shown in FIG. 9. After the operation starts (step 700), the function module checks to see whether the relay system is in NORMAL or SCAN mode (step 701). If the system is in NORMAL mode, the function module checks whether there is a link information request in the link information request queue (step 702). If there is, a link information request message is formed and sent out (step 703). If there is not, the function module checks whether there is any item in the broadcast priority queue (step 704). If there is, the broadcast priority queue is processed (steps 705-708) otherwise the module stops. Broadcast Priority Queue processing (step 705) is discussed in the next section.

The device information message is formed and sent out (steps 706, 707), and the device information items that have been sent out are updated (step 708). If a device information item has been sent out, then at step 708, its device information item will be removed from broadcast priority queue. In addition, its broadcast period will also be updated.

If the system is in SCAN mode, the function module decreases the scan period counter (step 709) and checks whether scan mode is ended (step 710). If scan mode is ended then the system mode is set to NORLAL (step 711) and the procedure ends (step 712).

### Broadcast Priority Queue Processing

Broadcast priority queue is used to set a device information broadcast order when several devices' information records need to be broadcasted in the same superframe. To prioritize the broadcasting of device information, each device information record waiting for broadcasting is associated with an eventflag. The eventflag is marked as UPDATE when device information has been changed (step 5035, 50310 and 50311) and reset to NOUPDATE after the information item is being broadcasted (step 708). The broadcast priority of device information item is determined by both eventflag and the order device ID inserted to the broadcast priority queue, which represents the broadcast counter expires order. In this step, device broadcast priority is re-ordered according to following rules: all device information items with UPDATE flag have higher priorities than those with NOUPDATE flags. For all device information items with UPDATE flags, priorities are given to the head of queue. Ties are broken randomly. The same rule applies to those device items with NOUPDATE flags. After this step, those device information records that have just been updated are given higher priority for broadcasting; device information records that have not been changed since last broadcast are given lower priorities.

### 2. Route Selection

Route selection is invoked whenever a new connection is to be established. In the following discussion the data transmission flow under relay system is firstly presented. Then topology map generation is discussed. Route selection based on maximal rate criteria and the topology map is proposed finally.

### Data Transmission Flow

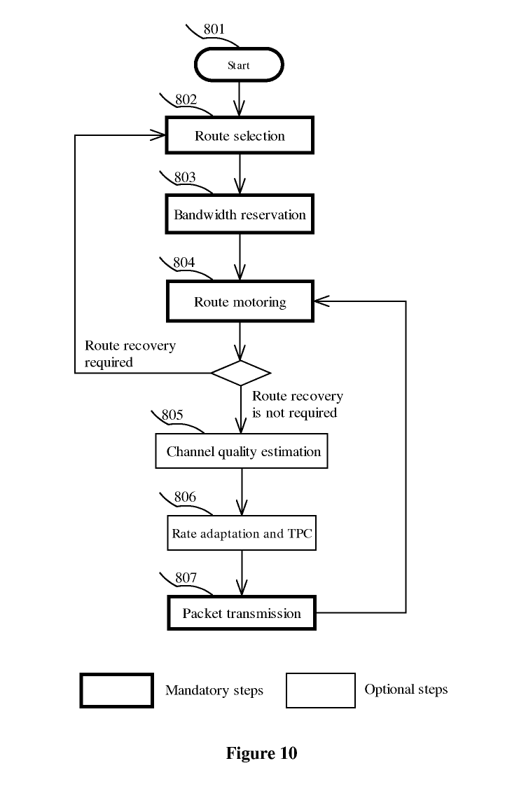

The data transmission flow is shown in FIG. 10. The operation procedure starts whenever there is a request from an application to establish a connection with another device (a traffic delivery request) in the network. A relay route is selected (may be directed communication) at the source node (step 802) and bandwidth is reserved along the selected route (step 803). The route is monitored during the process of data transmission (step 804). If the route monitoring module finds that a route is broken it goes back to step 802 and invokes route re-establishment mechanism. For system enhancement, the channel quality is estimated (step 805) and the rate adaptation and TPC are conducted (step 806) during data transmission. This procedure continues until the session is ended.

### Topology Map Generation

Based on the received device information, each device should maintain a data structure that could easily map the topology information of the whole network to a graph, to help select route when necessary. One possible way is to represent the topology information as a weighted directed graph. In this graph, node weight reflects the energy or power status of each device, link weight reflects link/channel condition, or available bandwidth between two devices within direct transmission range. The directivity reflects the capability of nodes, for examples, a non-relay node can only have in-edges. Any change in the network may affect the graph (topology map) by changing weight or the topology of the graph. The route is selected based on this graph (topology map). Other mapping methods can also apply here as long as they could represent the information, and can be easily used for route selection. Some source preference criteria can be applied in this step, for example, if local device does not want its traffic go through device A, then device A could be removed from the topology view when selecting the route.

When a traffic delivery request comes from application, the local device behaves as traffic source. The relay module selects route based on the topology view stored in local database and specific routing requirements from application. Route selection mainly depends on available devices for relay, available bandwidth, transmission rate as well as number of hops along the route. As the optimal route from source to some intermediate devices may not be part of optimal route from source device to the destination device, therefore, the greedy algorithm that selects route gradually may not work. Generally speaking, all feasible routes should be searched. A number of route objectives can be applied for route selection, such as maximal transmission rate, minimum source transmission power or minimal system interference. In the following part, algorithm on how to select maximal transmission rate route is discussed. Route selection algorithms based on other objectives can be derived, similar to the max rate route selection.

Maximal Rate Route Selection by Priori Prune Manipulation

As the complexity of optimal solution is large, a pre-processing mechanism is required to reduce the graph size by pruning unnecessary devices. The procedure can be shown as follows:

| | |
|---|---|
| STEP 1 | Get the original topology graph G, including the source device (S), |
| | destination (D), and all devices that are relay capable. Label the |
| | connectivity among the devices based on the connectivity information. |
| STEP 2 | On G, delete source device S from original network topology graph. |
| | From destination device D, start breadth-first search (BFS), record the |
| | relay devices (Set_D) that could be reachable from D. |
| STEP 3 | On G, delete device D from original network topology graph. From |
| | source device S, start BFS search, record the relay devices (Set_S) that |
| | could be reachable from S. |
| STEP 4 | Leave only relay devices within both Set_D and Set_S, and prune the others, |
| | which results in a reduced graph G′. The route selection |
| | algorithms would be performed based on the reduced graph G′, shown in |
| | following sections. |

Maximal Rate Route Selection based on the Pruned Topology
i. Locate a Route (Expansion-Based Algorithm)

An expansion tree is established with root S. All routes from S to D, which might incur better rate support, are recorded where the rate along a specific route can be calculated with the algorithm in the next subsection. The supportable transmission rate for direct transmission from S→D is set as a base rate level. The supportable rate is set as zero if two devices are not within each other's transmission range. The tree is expanded by inserting one level of intermediate relaying devices and the supportable rate from S to D is calculated through an intermediate device. Then, one more level is added; the result from S to D through two consecutive intermediate devices is calculated, and so on. Each time, only max rate routes obtained so far would be recorded. Considering the small size we are looking into, and in order to reduce the number of routes involved in calculation, one (maximum two) level(s) of intermediate nodes to relay would be enough for normal cases.

ii. Rate Support along a Path

A basic requirement for routing is ‘flow balance’, that is, the long term transmission rate over multiple devices along a route should be the same, thus

$$\{ \begin{matrix}{R}_{1} {F}_{1} = {R}_{2} {F}_{2} \\ {R}_{2} {F}_{2} = {R}_{3} {F}_{3} \\ {R}_{n - 1} {F}_{n - 1} = {R}_{n} {F}_{n} \\ {\sum }_{1}^{n} {F}_{i} = 1\end{matrix} ⇒ [ \begin{matrix}{R}_{1} & - {R}_{2} & & \\ & {R}_{2} & - {R}_{3} & \\ & & {R}_{n - 1} & {R}_{n} \\ 1 & 1 & 1 & 1\end{matrix} ] [ \begin{matrix}{F}_{1} \\ {F}_{2} \\ \\ {F}_{n}\end{matrix} ] = [ \begin{matrix}0 \\ 0 \\ \\ 1\end{matrix} ]$$

where, Ri is the transmission rate of i-th device along the route; Fi is the fraction of available slots Availslots assigned to i-th device. Availslots is used to denote the number of time slots that can be reserved along the path. Here Availslots=min{#of Assignable Slots on Device i}. The number of slots assigned to device i is Fi Availslots. The transmission rate for the traffic along the route is R=min {Ri×Fi Availslots/Total slots}.

### 3. Bandwidth Reservation

After the route selection, bandwidth, in terms of the number of time slots along the selected route should be reserved for traffic delivery. The main difficulty in the Bandwidth Reservation (BR) is parallel reservation among multiple applications. Conflicts may occur in this case, incurring massive bandwidth de-allocation and reservation retry procedures, which cause frequent reservation failure consequently. However, as a relatively small size network is considered in this invention, it is reasonable to enforce mutual exclusive bandwidth reservation, i.e. to allow only one source to perform bandwidth reservation for one application at a time. The difficulty is how to guarantee that at one time, only one connection may perform bandwidth reservation. In this work, we propose a Mutual-Exclusive Bandwidth Reservation (MEBR) protocol to resolve this problem. The details are discussed as follows.

In the scheme, each device keeps the flowing two flags, which have value either on (set) or off (unset).

| Flag | Description |
|---|---|
| BR_Indicate | Set on when local device recognizes that there is another |
| | device performing bandwidth reservation. |
| BR_Notify | Set on when any BR Notify message has been received |
| | from another device, or the device itself sends out such a |
| | message to request bandwidth reservation. |

Both ‘BR Indicate’ and ‘BR Notify’ are set as off (unset) when the system starts up or after reset.

In addition the following timers are maintained by the scheme.

| Timer | Description |
|---|---|
| BR_Notify_Retry_Counter | Used to check network status to retry |
| | sending out ‘BR Notify’ message, to get |
| | BR access right. |
| BR_Notify_Send_Timer | Used to decide ‘BR Notify’ has reached |
| | all devices in the network, and no conflict |
| | exists. |
| BR_Reply_Timer | Set at the devices (except the destination) |
| | along the selected route, for waiting for |
| | ‘BR_Reply’ from down-link device. |

The following messages might be delivered in the network

| Message | Description |
|---|---|
| BR Notify | (broadcast) indicating a device's willingness to send out a |
| | bandwidth reservation (BR) request. |
| BR Conflict | (broadcast) indicating conflict of BR detected in the network. |
| BR Right Confirm | (broadcast) indicating the device would start bandwidth reservation. |
| BR Request | (unicast) send from source device to destination to pass |
| | bandwidth reservation related information along the selected |
| | pass, parameters include (selected devices along the path, traffic |
| | specification (TSpec), traffic info). |
| BR Reply | (unicast) send from destination device to source as reply to ‘BR |
| | request’. |
| BR Error | (unicast), generated when any error occurs during bandwidth |
| | reservation. It is send bi-directionally to source and destination |
| | along the selected route. |
| BR Release | (unicast), send from source device to destination to release |
| | previously reserved bandwidth |
| BR Right Release | (broadcast), send out after the source device find that it has |
| | successfully reserve the bandwidth along the path. |

Each message is classified as either broadcast type or unicast type. If it is a broadcast type, then a message flooding mechanism should be adopted to make sure that the message reaches all devices in the network. If it is a unicast type, then the message is sent from source to its destination.

a. Mutual Exclusive BR Right Acquisition

Any source device needs to obtain the BR right first before invoking bandwidth reservation along the route, to guarantee only one source performing bandwidth reservation in the network. Basically, a device needs to notify all other devices if it needs to conduct bandwidth reservation. Since the network is distributed, devices may issue bandwidth request concurrently, in this invention, an exponential backoff algorithm is used to solve conflicts. Basically, exponential back off algorithm works as follows: each device maintains a contention window. There is a predefined minimal value and maximal value in terms of time for the contention window. Initially contention window is set as minimal value. If the device fails to get access right after a try, its contention windows is doubled until the maximal value is reached, then a random value within contention window is chosen as the waiting period for a waiting timer for the device to do backoff. If the timer expires, then the device can conducts another try. The detail of the scheme can be described as follows.

When a device, for example device A, wants to invoke a bandwidth reservation, it firstly checks the local ‘BR_Indicate’ as follows:
If ‘BR_Indicate’ is on, indicating a source is performing BR, device A waits a certain amount of time before the next checking.
If ‘BR_Indicate’ is off and a ‘BR Notify’ is received previously, a back-off counter ‘BR_Notify_Retry_Counter’ is set for next checking.
If ‘BR_Indicate’ is off and no ‘BR Notify’ is received, send out ‘BR Notify’ message, start a ‘BR_Notify_Send_Timer’.

In case device A receives ‘BR Notify’ message:
If ‘BR_Indicate’ for another application is on, device A broadcasts a ‘BR Conflict’ message.
If ‘BR_Indicate’ is off and ‘BR_Notify’ is on, i.e. receive ‘BR Notify’ already from different source nodes, or different application or the device itself has sent out ‘BP Notify’, A broadcasts a ‘BR Conflict’ message.

In case a device (A) received ‘BR Conflict’ message, A performs the following:
A broadcasts a relay ‘BR Conflict’ information.
Checks whether the device itself sent out ‘BP Notify’ in the current period. If yes, conduct an exponential back off for another try.
A clear the ‘BR_Notify’ to off.

If ‘BR_Notify_Send_Timer’ timeout, i.e. no ‘BR Conflict’ or other ‘BP Notify’ received from other nodes after device A sends out ‘BR Notify’, A performs the following,
Send out ‘BR Right Confirm’ message.

Any device that receives ‘BR Right Confirm’ message should
Set ‘BR Indicate’ flag to on.

If a device (A) has finished the bandwidth reservation, it should
Use ‘BR Right Release’ to release bandwidth reservation right.
   b. Route Selection and Bandwidth Reservation

After the device acquires the bandwidth reservation right,

| | |
|---|---|
| STEP 1 | Source device selects the route based on the route selection algorithm discussed |
| | in the last section. |
| STEP 2 | Bandwidth reservation protocol is performed along selected route as |
| | follows: |
| | Firstly, the source does the following |
| | 1. Set up routing table; |
| | 2. Conduct bandwidth reservation with next hop device through DRP |
| | protocol provided by MAC layer. |
| | 3. Update and broadcast its device information; |
| | 4. Send ‘BR request’ to the next hop device. |
| | 5. Keep a timer for ‘BR reply’. |
| | On receiving of ‘BR request’, any intermediate device along the path |
| | do the similar step as source device. |
| | On receiving ‘BR request’, the destination |
| | 1. Record in routing table; |
| | 2. Generate ‘BR reply’ back to pre-hop device |
| | On receiving of ‘BR reply’, any intermediate device forward the BR |
| | reply to pre-hop device |
| | On receiving ‘BR reply’, the source indicates the successful |
| | bandwidth reservation to the upper layer. |
| | The source device sends out ‘BR right release’ message to release BR |
| | access right. |
| | All reservation along the path is cancelled in case: |
| | receiving a ‘BR Error’ message, indicating any error in the |
| | procedure, either route is broken or bandwidth reservation is |
| | failed, such ‘BR Error’ will be forwarded to pre-hop device. |
| | ‘BR_reply_timer’ expires. |
| | The source device sends out ‘BR release’ message to release BR |
| | access right upon receiving ‘BR Error’ message or its ‘BR_Reply_timer’ |
| | expires, and then source device needs to send ‘BR release’ message to |
| | release the reserved bandwidth along the route and send ‘BR right release’ |
| | later to release reservation right. |
| STEP 3 | After the bandwidth reservation, the reserved slots can be dedicatedly |
| | used for the traffic delivery; upper layer of source device can start data |
| | transfer. |

c. Route Release

When source device finishes data transfer for an application, it should do the following four steps:
1. Release the bandwidth reserved for the application.
2. Send out ‘BR Release’ message to the next-hop device along the data delivery route,
3. Remove the record related to the application.
4. Update device information.

On receiving the ‘BR Release’ message from pre-hop device, an intermediate device should perform the same four steps as the source device.

When the ‘BR Release’ reaches the destination the related routing and bandwidth reservation record is removed from destination.

What is claimed is:

1. A routing and/or bandwidth reservation method for wireless communication in a small scale distributed network having a plurality of network members comprising at least one source member and one destination member, the method comprising:
establishing in every member of the network a stored topological overview of the entire network,
in response to a data transmission request being generated or received at the source member, determining at the source member a route for the transmission using the stored topological view of the entire network, the route including the source member and the destination member,
reserving bandwidth along the selected route,
transmitting data from the source member to the destination member along the route utilizing the reserved bandwidth, and
upon completion of the transmission releasing the reserved bandwidth along the route.

2. The method of claim 1 wherein the network further includes an intermediate member and the route includes the source member, the intermediate member and the destination member.

3. The method of claim 1 wherein establishing in every member of the network a stored topological view of the entire network comprises, at each member of the network, collecting and storing information about all other members of the network including information about connection paths between the members of the network.

4. The method of claim 2 wherein the information comprises, for each member of the network, a network ID, a routing ability and a state of connections between the device and other devices in the network.

5. The method of claim I wherein establishing in every member of the network a stored topological view of the entire network comprises collecting and broadcasting of information by members of the network, receiving the broadcast information and storing the information in members of the network, and if necessary re-broadcasting stored information.

6. The method of claim 4 wherein the broadcasting and re-broadcasting of information is priority based so as not to utilize excessive network recourses.

7. The method of claim 1 wherein determining a route for the transmission is based on criteria selected from group comprising maximum transmission rate, maximum transmission path signal strength, minimum transmission power and minimum transmission path interference.

8. The method of claim 1 wherein bandwidth reservation is based on a mutually exclusive reservation scheme such that only one connection of the network may reserve bandwidth at any one time.

9. The method of claim 1 where the method is controlled by a layer inserted into the network protocol stack of members of the network.

10. The method of claim 9 where the layer is inserted into the network protocol stack directly above the media access control layer.

11. A device for participating a small scale distributed wireless network, the device comprising a relay application for establishing a stored topological overview of the entire network and in response to a data transmission request being generated or received at the device, determining a route for the transmission of the data using the stored topological overview of the network, initializing a bandwidth request along the selected route, and after the transmission of data along the route, initializing the release of the reserved bandwidth.

12. The device of claim 10 wherein to establish a stored topological view of the entire network, the relay application collects and stores information about all other members of the network including information about connection paths between the members of the network.

13. The device of claim 11 wherein the information comprises, for each member of the network, a network ID, a routing ability and a state of connections between the device and other devices in the network.

14. The device of claim 10 wherein to establish a stored topological view of the entire network the relay application collects and broadcasts information about the device and receives and stores broadcast information of other members of the network.

15. The device of claim 13 wherein the broadcasting and re-broadcasting of information is priority based so as not to utilize excessive network recourses.

16. The device of claim 15 further including a priority based scheduling scheme for periodically broadcasting and re-broadcasting the information based on an adjustable broadcast period, said broadcast period being adjusted such that stable information is broadcasted less frequently than changed information.

17. The device of claim 10 wherein determining a route for the transmission is based on criteria selected from group comprising maximum transmission rate, maximum transmission path signal strength, minimum transmission power and minimum transmission path interference.

18. The device of claim 10 wherein bandwidth reservation is based on a mutually exclusive reservation scheme such that only one connection of the network may reserve bandwidth at any one time.

19. A relay system for wireless communication in a small scale distributed network, the system comprising having a plurality of network members including at least one source member and one destination member, and a relay application in each member of the network, the relay application responsible for:
establishing in every member of the network a stored topological view of the entire network,
in response to a data transmission request being generated or received at the source member, determining at the source member a route for the transmission using the stored topological view of the entire network, the route including the source member and the destination member,
reserving bandwidth along the selected route, and
upon completion of data transmission, releasing the reserved bandwidth.

20. The relay system of claim 19 wherein the network further includes an intermediate member and the route includes the source member, the intermediate member and the destination member.

21. A method for providing routing control in a distributed wireless multi-hop network consisting of a plurality of nodes, the method comprising in each node of the network:
establishing a stored table comprising an entry for every other node in the network that identifies the neighbors of said other nodes,
in response to a data transmission request being generated or received, using the table to select a route for the requested data transmission, said route included at least two of said other nodes, and
initiating a bandwidth reservation request along the selected route.
